(19) United States
(12) Patent Application Publication
(10) Pub. No.: US 2015/0001359 A1
(43) Pub. Date: Jan. 1, 2015

(54) REMOVABLE ACCESSORY CLIP SYSTEM AND FLANGE FOR A REMOVABLE ACCESSORY CLIP SYSTEM

(71) Applicant: NOVA ORTHO-MED, INC., Carson, CA (US)

(72) Inventor: Michael Dennis Catchings, Savoy, TX (US)

(21) Appl. No.: 13/931,112

(22) Filed: Jun. 28, 2013

(51) Int. Cl. F16M 13/02; F16M 13/06

(52) U.S. Cl. CPC F16M 13/02; F16M 13/06
USPC 248/220.22; 248/200; 248/230.1

(57) ABSTRACT

A removable accessory clip system for temporarily attaching at least one of a plurality of accessories to an object, particularly a vertical or horizontal post of a medical object, e.g., a walker, a cane, a wheelchair, a stretcher, or a medical device hanger. A flange assembly includes at least a first flange portion attachable to the object, and at least a second flange portion attachable to the first flange portion. A key-hole plate is removably attachable to the second flange portion via a snap-fit. The key-hole plate includes, attached thereto, accessory-holding structure for temporarily holding the at least one of the plurality of accessories. The snap-fit between the key-hole plate and the second flange portion enables the accessory clip to be assembled, attached to the object, removed, and reconfigured with another accessory-holding structure for holding a different accessory to the same or a different object, with use of a minimal number of tools.

### FIELD OF THE INVENTION

The present invention relates to a removable accessory clip system, and a flange assembly for a removable accessory clip system, for removably attaching at least one of a plurality of accessories to an object, which requires a minimal use of tools to quickly and easily attach or detach the flange assembly to the object, to quickly and easily attach the remaining components of the removable accessory clip system to the flange assembly, to easily attach the accessory to the removable accessory clip system, and to quickly and easily remove and reconfigure the removable accessory clip system from the object to hold a different accessory. The objects to which the accessory clip system is configured to attach include, but are not limited to, vertical and horizontal post portions of medical devices, e.g., walkers, canes, wheelchairs, hospital beds, and medical equipment hanging posts, as well as non-medical devices, e.g., sports helmets.

### BACKGROUND OF THE INVENTION

Several objects are known wherein the user thereof either has his or her hands full, or for other reasons is unable to hold on to at least one of a plurality of accessories. For example, in a medical context, a patient unable to walk without assistance of a walker or a cane often needs both of his or her hands to grip the walker or the cane, and has difficulty simultaneously freeing a hand to hold on to desirable accessories, such as a purse, a set of keys, a briefcase, a personal items bag, a flashlight, a cup or a bottle of liquid, or the like. Likewise, hospital personnel and emergency providers pushing a patient into a hospital or ambulance on a stretcher or in a wheelchair may have no free hand or no hanger on which to hang, e.g., an I.V. bag, a blood bag, a catheter bag, a cardio-respiratory apparatus, a medical chart, the patient's personal items, or the like. In a non-medical context, a scuba diver, a deep-sea diver, or a skier may be swimming or holding ski poles, respectively, and therefore lack free hands to hold a camera or another desirable accessory.

To date no accessory-holding system has been developed or made available that can be easily assembled, is easily attachable and easily detachable from objects such as those mentioned above, is configured to hold at least one of a plurality of accessories, and can be easily removed and reconfigured to hold different accessories, requiring only a minimal use of tools. Previous attempts to attach accessories to objects such as those described above have not worked well, have been expensive, have been difficult to assemble, have been difficult to attach to the objects, or have been difficult to remove and reconfigure.

It is desirable to have a removable accessory clip system for removably attaching an accessory to at least one of a plurality of objects, wherein such a clip system can be assembled easily and quickly with a minimal number of tools, and mounted on the object, and wherein the clip system also can be easily attached, removed, and reconfigured to hold a different accessory.

This is achieved by a removable accessory clip for removably attaching at least one of a plurality of accessories to an object, which solves the shortcomings of the prior art.

### SUMMARY OF THE INVENTION

In accordance with the invention, a removable accessory clip system temporarily attaches at least one of a plurality of accessories to an object. The object may be, but is not limited to, an object used in the medical field, e.g., a walker, a cane, a stretcher, a wheelchair, a hospital bed, or a hanger for medical accessories such as I.V. bags, blood bags, catheter bags, cardio-respiratory equipment, medical charts or the like. Non-medical accessories may be, but are not limited to, drinking cups and bottles, flashlights, canes, keys, mobile phones, personal item bags, briefcases, cameras, or the like.

In accordance with the invention, the removable accessory clip system includes a flange assembly removably attachable to the object, the flange assembly including at least a first flange portion and at least a second flange portion removably attachable to the first flange portion. A key-hole plate is removably attachable to the second flange portion via a snap-fit. The key-hole plate includes an accessory-holding structure attached thereto for removably attaching at least one of the accessories.

In one preferred embodiment, the flange assembly further includes a third flange portion, the third flange portion having a base portion, and first and second legs ending in respective first and second distal ends, defining a generally C-shaped configuration, the base portion configured to fit against a pipe portion, and the first flange portion being removably attachable to at least one of the first and second distal ends to substantially enclose the pipe portion.

It is further preferable, but not required, that the first flange portion has a generally oval shape defining a vertical plane, and the second flange portion has a generally-circular face portion attached to a shaft projecting substantially normal with respect to the plane defined by the first flange portion. The shaft has a diameter, and a circumferential surface, with a plurality of recesses defined at spaced intervals in the surface.

in a preferred embodiment, the key-hole plate has defined therein a substantially figure 8-shaped opening, with a first opening portion having a first diameter, and a second opening portion having a second diameter smaller than the first diameter, and a pair of projecting portions between the first and second opening portions. The second diameter also is approximately equal to the diameter of the shaft. The key-hole plate also has attached thereto the accessory-holding structure for holding a desired accessory. The accessory-holding structure can be integral with the key-hole plate, or can be attached thereto with fasteners. In this embodiment, in order to affect the snap-fit between the key-hole plate and the second flange portion, the second flange portion is inserted into the larger first opening portion, and the key-hole plate is moved toward the second opening portion until the second flange portion shaft snaps past the two projecting portions and into the second opening portion. The smaller diameter of the second opening portion, combined with the two projecting portions, removably hold the key-hole plate in place between the first and second flange portions with the snap-fit. In order to remove the key-hole plate, the above procedure is performed in reverse. The key-hole plate can then be reconfigured to have a different accessory-holding structure fastened thereto, or replaced with a key-hole plate having a different integral accessory-holding structure.

In a preferred embodiment, the key-hole plate is provided with a generally vertically-oriented tooth portion projecting from the second opening portion. During assembly, the tooth portion snaps into a vertically-oriented slot on the shaft. An upward pointed arrow defined on the generally-circular face of the second flange portion points toward the slot into which the vertically-oriented tooth portion will project, thereby assisting the user in properly orienting the key-hole plate during assembly.

In another preferred embodiment, the key-hole plate is generally rectangular, and has a generally C-shaped opening on one edge, and the accessory-holding structure attached to another edge, e.g. structure configured to removably hold a flashlight. In this embodiment, the generally C-shaped opening includes a projecting portion configured to effect the snap-fit with the second flange portion. The key-hole plate may thereby rotate with respect to the second flange portion.

In another preferred embodiment of the flange assembly, the first flange portion has a recess provided therein, defining a socket, and a distal end of the second flange portion shaft includes a sphere, configured to fit into the socket to define a pivotal ball and socket connection.

In another preferred embodiment, the first flange portion can be configured to attach to a surface of a helmet, without requiring a third flange portion. The accessory holding structure extending from the key-hole plate in this embodiment can be, e.g., structure for removably holding a camera.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several presently preferred embodiments of the invention and together with the description, serve to explain the principles of the invention.

### BRIEF DESCRIPTION OF THE DRAWINGS

FIG. 1 is a perspective view of a walker having mounted thereon a removable accessory clip system for removably attaching at least one of a plurality of accessories to the walker, with one possible accessory-holding structure, and two additional separate flange assemblies for use with removable accessory clip systems, in accordance with the invention;

FIG. 2 is a perspective view of a portion of a walker, having mounted thereon, a removable accessory clip system, and two additional separate flange assemblies for use with removable accessory clip systems in accordance with the invention;

FIG. 3 is a perspective view of a portion of a walker, similar to FIG. 2, with the removable accessory clip system depicted as being fully assembled and mounted in a different position than in FIG. 2;

FIG. 4 is a front cross-sectional view of the flange assembly and the key-hole plate of the removable accessory clip system of FIGS. 1-3, depicted with the face portion of the second flange portion removed in order to depict interaction between the shaft portion of the second flange portion, and the key-hole plate;

FIG. 5 is a side cross-sectional view of the flange assembly and the key-hole plate of the removable accessory clip system of FIGS. 1-4;

FIG. 6 is a perspective exploded parts view of the removable accessory clip system of FIGS. 1;

FIG. 7 is a perspective view of another embodiment of the removable accessory clip system in accordance with the invention;

FIG. 8 is a perspective exploded parts view of the embodiment of the removable accessory clip system depicted in FIG. 7;

FIG. 9 is a perspective view of another embodiment of the removable accessory dip system in accordance with the invention mounted on a cane with a different embodiment of the key-hole plate and an accessory-holding structure for holding, e.g., a flashlight;

FIG. 10 is a perspective exploded parts view of the embodiment of the removable accessory clip system depicted in FIG. 9;

FIG. 11 is a side view of the embodiment of the removable accessory clip system depicted in FIGS. 9 and 10, with the key-hole plate and the flashlight rotated to a position approximately 90 degrees with respect to a substantially vertical axis defined by the cane;

FIG. 12 is a side view of the embodiment of the removable accessory dip system depicted in FIGS. 9 and 10, with the key-hole plate and the flashlight rotated to a position approximately 30 degrees to 45 degrees with respect to the substantially vertical axis defined by the cane;

FIG. 13 is a side view of the embodiment of the removable accessory clip system depicted in FIGS. 9 and 10, with the key-hole plate and the flashlight rotated to a position approximately 120 degrees to 135 degrees with respect to the substantially vertical axis defined by the cane;

FIG. 14 is a perspective view of a walker, having mounted on a vertical post portion thereof, another embodiment of the removable accessory clip system of the present invention, with another accessory-holding structure for holding, e.g., a briefcase;

FIG. 15 is a partial perspective view of a key-hole plate of the embodiment of the removable accessory dip system depicted in FIG. 14 with a briefcase attached thereto;

FIG. 16 is a perspective view of another embodiment of the flange assembly for use with the removable accessory dip system of the present invention, ideally suitable for removable attachment to angled posts, e.g., angled front horizontal posts of a walker;

FIG. 17 is a top view of the flange mechanism of FIG. 16 positioned on a horizontal angled post portion of a walker, depicting a ball and socket engagement between the first and second flange portions;

FIG. 18 is a perspective exploded parts view of the ball and socket flange mechanism of FIGS. 16 and 17;

FIG. 19 is a top cross sectional view of the flange mechanism of FIG. 17, depicting a range of motion of the ball and socket attachment;

FIG. 20 is an exploded-parts perspective view depicting another embodiment of a removable accessory clip system in accordance with the invention, for mounting an accessory, e.g., a camera, to a helmet;

FIG. 21 is a perspective view of the embodiment of the removable accessory clip system of FIG. 20;

FIG. 22 is a perspective view of a wheelchair, having mounted thereon a removable accessory clip system in accordance with the invention;

FIG. 23 is a perspective view of a stretcher, having mounted thereon a removable accessory clip system in accordance with the invention; and

FIG. 24 is a perspective view of a rolling medical bag hanger post, having mounted thereon a removable accessory clip system in accordance with the invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

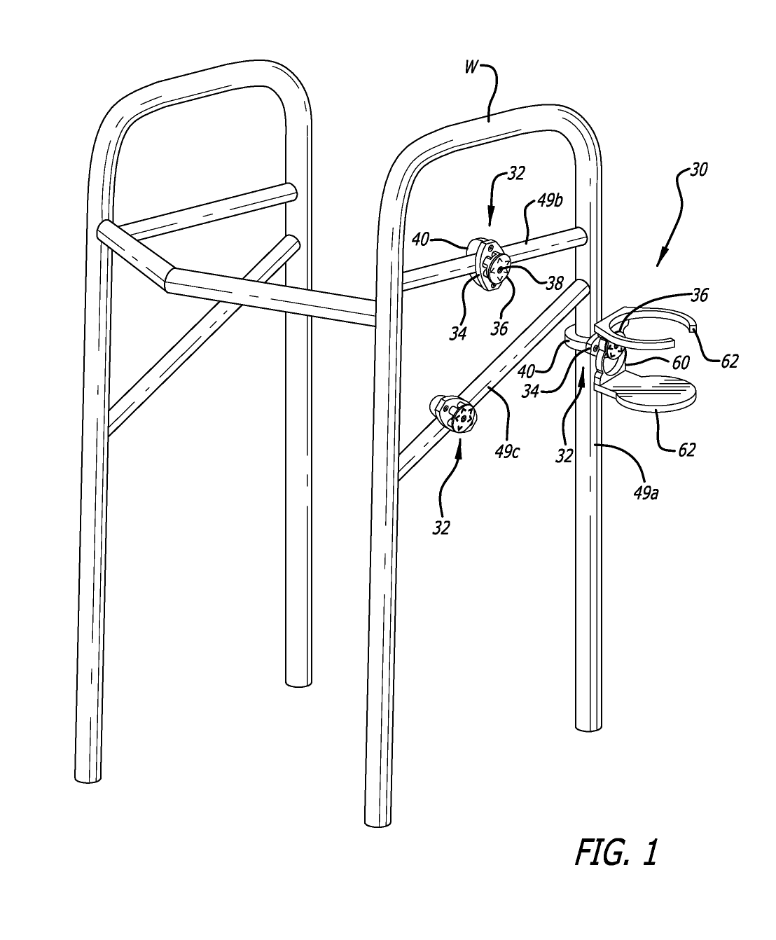

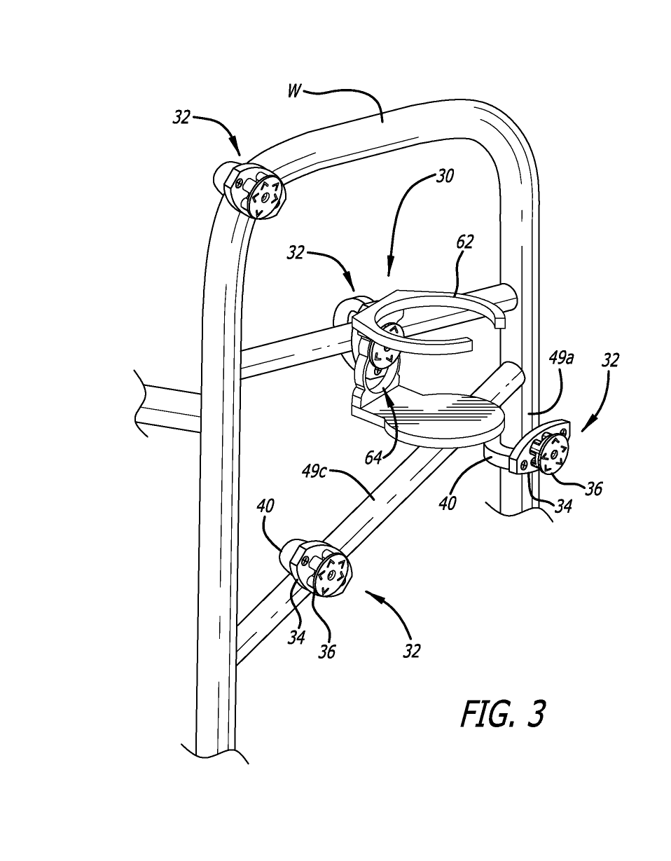

In accordance with the invention, and as broadly embodied herein a removable accessory clip system 30 is provided for attaching at least one of a plurality of accessories to an object, e.g., a walker W in FIGS. 1-3.

In accordance with the invention, and as broadly embodied, e.g. in FIGS. 1-6, a first preferred embodiment of removable accessory clip system 30, in accordance with the invention includes a flange assembly 32. Flange assembly 32 includes a first flange portion 34. As broadly embodied in FIGS. 1-6, first flange portion is generally oval-shaped and generally planar, thereby defining a plane. Flange assembly 32 further includes a second flange portion 36, attached to first flange portion 34 with a fastener 38, e.g. a cross-head screw. As broadly embodied in FIGS. 1-6, a third flange portion 40 is provided. As embodied herein, third flange portion 40 is generally C-shaped, having a base portion 42 configured to fit against a portion of the post to which the removable accessory clip system 30 is to be mounted, and first and second legs 44a and 44b, projecting from the base portion 42 to distal ends 46a and 46b, respectively. Distal ends 46a and 46b are configured to be attached to the first flange portion 34, preferably with fasteners 48a and 48b, e.g., cross-head screws.

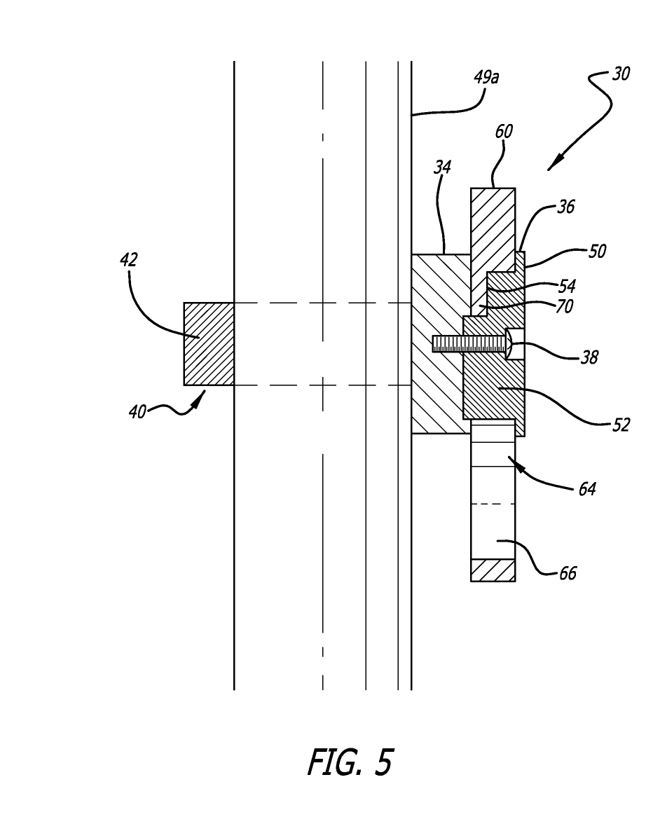

In accordance with the invention, and as broadly embodied, e.g., in FIGS. 1-4 and 6, second flange portion 36 includes a generally circular face portion 50 and a shaft 52 attached to the face portion 50. The shaft 52 is disposed generally normal to the plane defined by the first flange portion 34, as best shown, e.g., in FIG. 5. The shaft 52 is configured with a plurality of slots 54 defined at periodic spaced intervals in the periphery of the shaft 52. Preferably, the face portion 50 has defined therein a plurality of spaced arrows 56, pointing toward the circumference of the generally circular face portion. Each arrow 56 is defined on the face portion 50 in a position such that it substantially points toward a position of a corresponding slot 54 on the shaft 52.

In accordance with the invention, and as broadly embodied herein, the removable accessory clip system 30 includes a key-hole plate 60, removably attachable to, and detachable from, the second flange portion 36 via a snap-fit, without the need to use a tool. The key hole plate 60 also includes attached thereto an accessory-holding structure 62 for removably holding the at least one of the plurality of accessories. The accessory-holding structure 62 may be attached to the key-hole plate 60, e.g., with fasteners, or may be formed as an integral component with the key-hole plate 60. As broadly depicted, e.g., in FIGS. 1, 2, 3, and 6, accessory-holding structure 62 comprises a cup holder, but many other structures are available for use with the present invention, and will be discussed below.

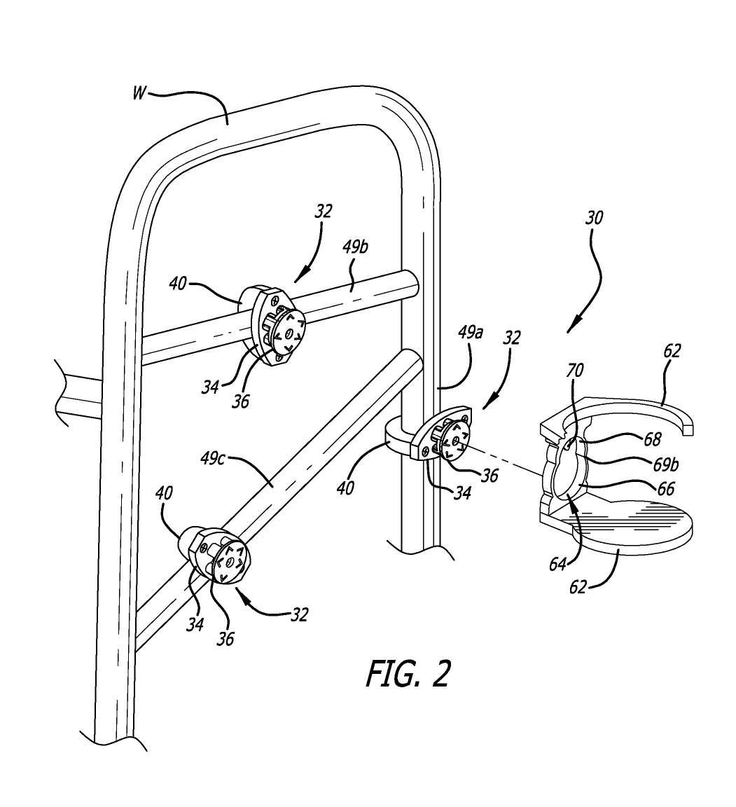

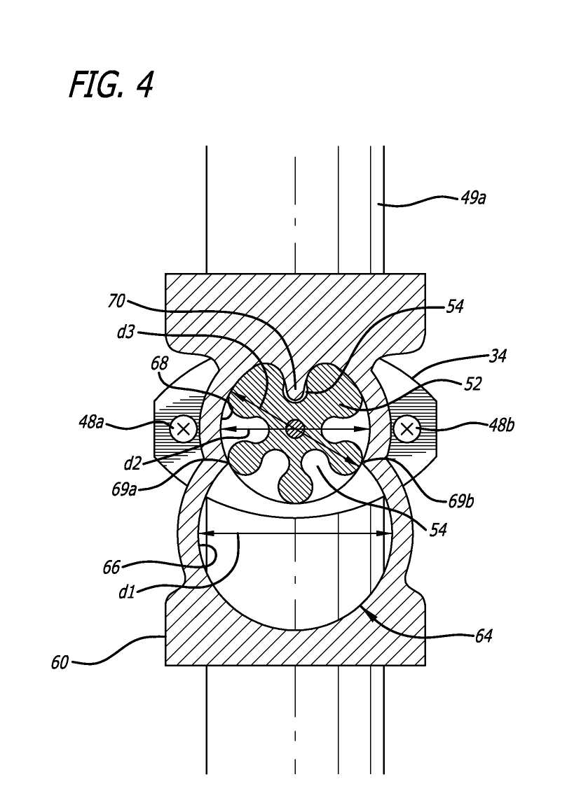

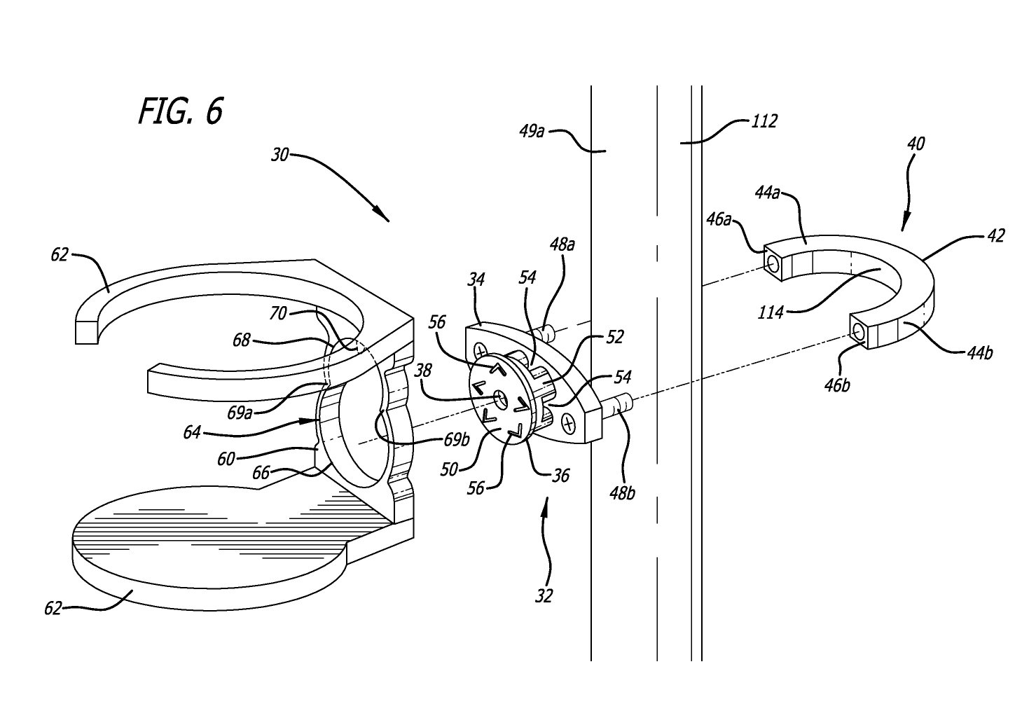

As broadly embodied herein, with reference, e.g., to FIGS. 1-5, the snap-fit between the key-hole plate 60 and the second flange portion 36 is affected, without using tools as follows. The key-hole plate 60 preferably has defined therein, an opening 64 shaped substantially as a figure 8. Referring, e.g., to FIG. 4, figure 8-shaped opening 64 has a first opening portion 66 having a first diameter d1, and a second opening portion 68 having a second diameter d2, which is smaller than d1, and substantially equal to a diameter d3 of the shaft 52. Between the first and second openings 66 and 68 of figure 8-shaped opening 64 are a pair of inwardly projecting portions 69a/69b. The generally circular face 50 of the second flange portion 36 is inserted through the larger first opening portion 66, as shown, e.g., in FIGS. 2 and 6, and then the key-hole plate 60 is moved toward the first opening portion 68. The projecting portions 69a/69b temporarily flex outward, then snap back inward toward the shaft 52, as the shaft 52 enters the second opening portion 68. At that position, as shown, e.g., in FIGS. 1, 3, and 4, the key-hole plate 60 is held between the first flange portion 34 and the second flange portion 36 via the compressive force of the smaller diameter d2 of the second opening portion 68 and the spring force of the projecting portions 69a and 69b (defined herein as the “snap-fit”). One of ordinary skill will recognize, moreover that the key-hole plate 60 can be removed from the second flange portion 36, without using tools for example to change the accessory holding structure 62, simply by reversing the above snap-fit procedure.

In accordance with the invention, and as broadly, e.g., in FIG. 4, the key-hole plate 60 further includes a projecting tooth portion 70. When the key-hole plate 60 is attached to the second flange portion 36, as described above, the tooth portion 70 will insert into an upward-oriented slot 54 on the shaft 52. During this assembly, an upward-pointing arrow 36 acts as a guide to the user to assemble the clip system 30, by orienting the components so that the tooth 70 snaps into the properly-oriented slot 54.

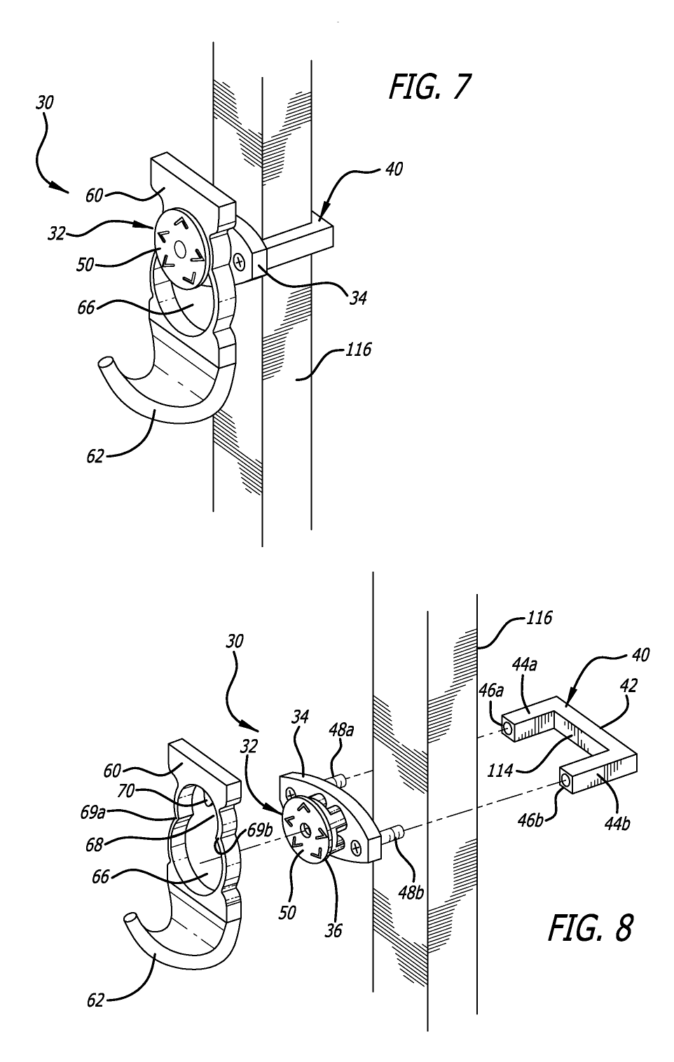

In accordance with the invention, FIGS. 7 and 8 broadly depict the removable accessory clip system 30 of the present invention, with a different accessory-holding structure 62 attached to the key-hole plate 60. In this embodiment, accessory-holding structure 62 is configured in the general shape of a hook, which is useful for removably holding both non-medical accessories such as, e.g., purses, individual accessory tern bags, keys, and so on, and medical accessories such as, e.g., an I.V. bag, a blood bag, a catheter bag, a cardio-respiratory apparatus, a medical chart, and the like.

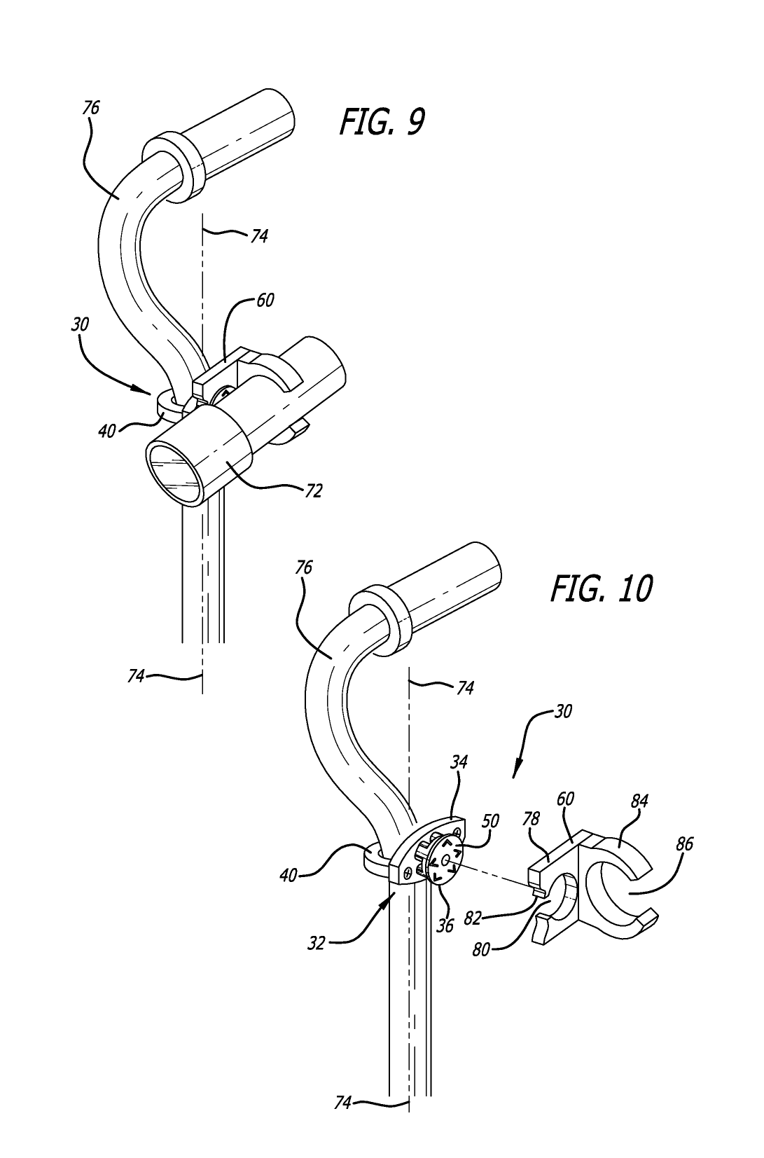

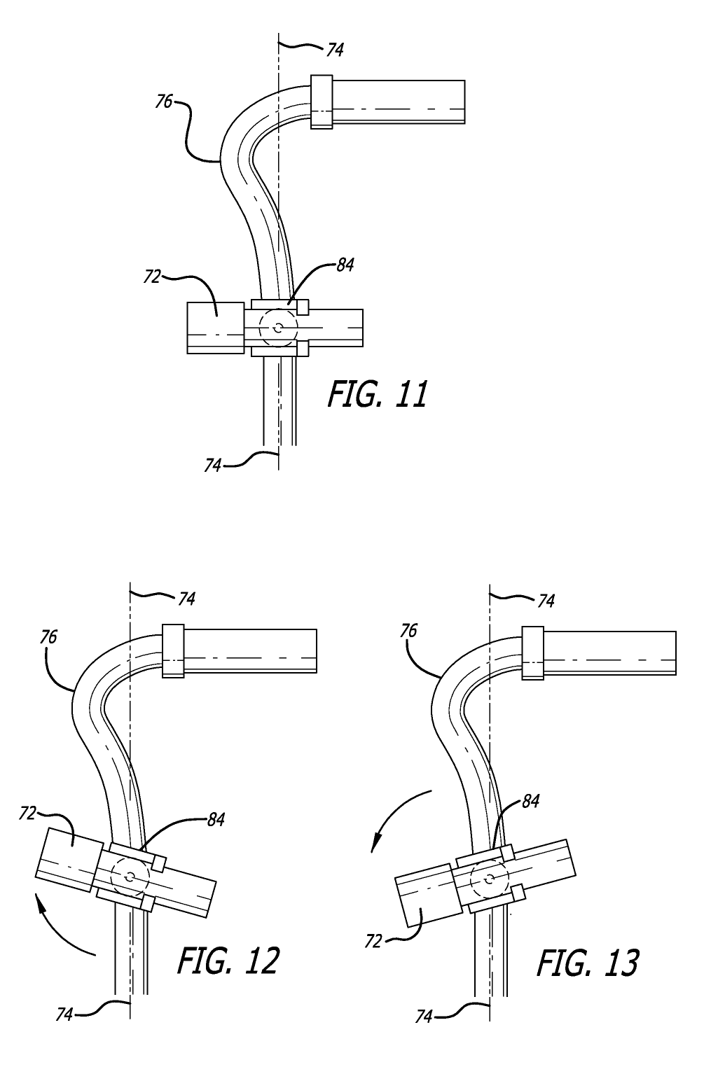

In accordance with the invention, another embodiment, broadly embodied, e.g., in FIGS. 9-13, is provided for removably holding an accessory, e.g., a flashlight 72, to be rotatable with respect to an imaginary axis, e.g., an imaginary vertical axis 74 defined by, e.g., a walking cane 76. Referring to FIGS. 9-13, the key-hole plate 60 in this embodiment includes a generally-rectangular base plate 78, having a first generally C-shaped opening 80 in one edge thereof. The generally-C shaped opening 80 is configured to removably rotatably engage the second flange portion 36, The generally C-shaped opening 80 includes at least one projecting portion 82. The generally C-shaped opening 80 and the projecting portion 82 are configured to engage the shaft portion 52 of second flange portion 36 with a snap-fit, and apply friction and pressure to the shaft 52 in order to enable base plate 78 to rotate freely, but also be temporarily held at a desired angle with respect to the imaginary axis 74. The embodiment of the key-hole plate 60 in FIGS. 9-13 further includes a holding plate 84 attached generally transversely to the base plate 78. Holding plate 84 includes a second generally C-shaped opening 86 defined in one side thereof, configured to removably hold, e.g., the flashlight 72. Referring to FIGS. 11-13, one of ordinary skill will understand that due to the rotatable connection between the base plate 78 and the second flange portion 36, the user of cane 76 can rotate the flashlight 72 through a wide range of angles with respect to the vertical axis 74. For example, FIG. 11 depicts the flashlight 72 positioned generally parallel with the horizon, i.e., generally transverse with respect to the imaginary vertical axis 74 defined by the cane 76. FIG. 12 depicts the flashlight 72 positioned at an angle of approximately 30 degrees to 45 degrees with respect to the imaginary vertical axis 74, whereas FIG. 13 depicts the flashlight rotated approximately 120 degrees to 135 degrees with respect to the imaginary vertical axis 74. Moreover, due to the pressure and friction applied by projecting portion 82 against the second flange portion 36, the user can temporarily leave the flashlight 72 positioned at a desired angle until the user rotates it to a different angle, or removes it from the C-shaped opening 86.

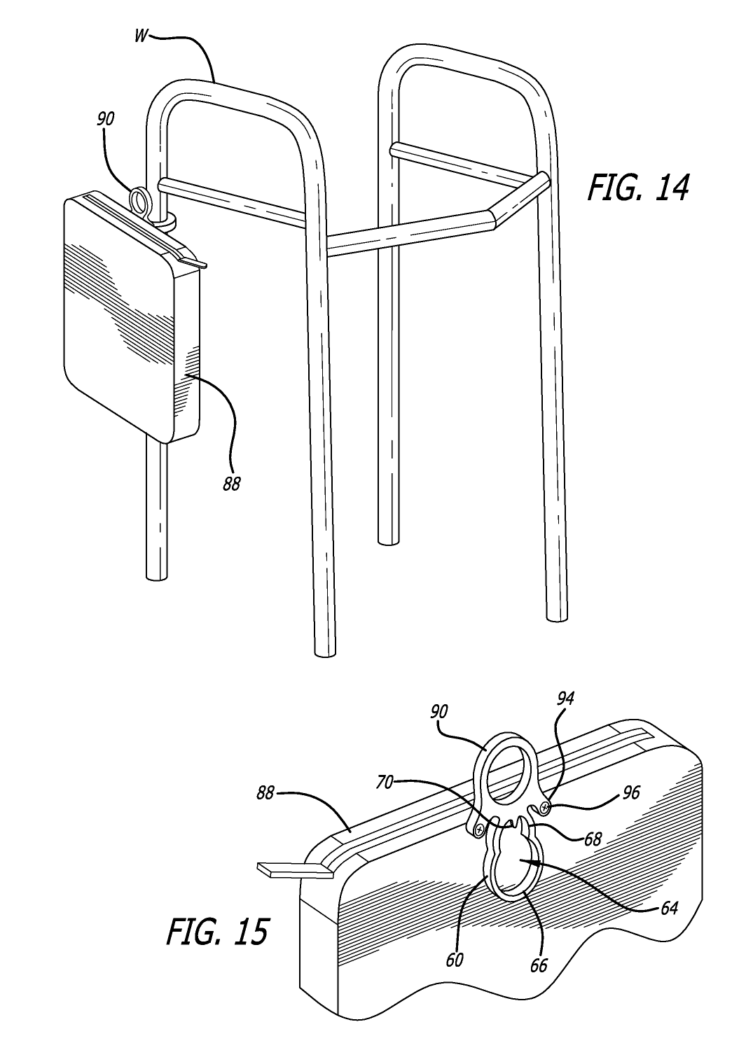

FIGS. 14 and 15 broadly depict another embodiment of the present invention, useful for attaching, e.g., a luggage or briefcase 88 to an object, e.g., a walker W. Referring to FIG. 15, key-hole plate 60 includes an upper generally annular portion 90 defining an annulus. Generally annular upper portion 90 can serve several purposes, including lifting the briefcase 88 to engage it with the accessory clip 30 (not shown) or to hang additional accessories therefrom. Generally annular upper portion 90 further includes at least one rabbit ear-shaped projection 94 for attaching the generally annular upper portion 90 to the briefcase, e.g. with a cross-head screw 96. Once fastened to the briefcase, the figure 8-shaped opening 64 of the key-hole plate 60 can be removably mounted on the second flange portion with the snap-fit, in the manner described above.

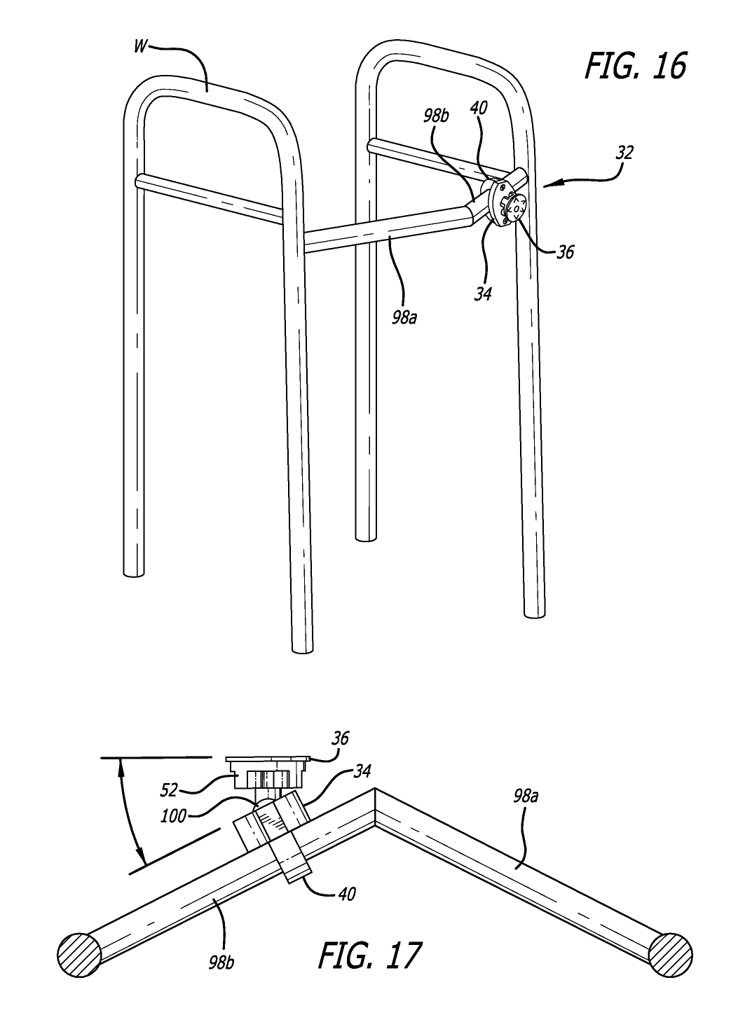

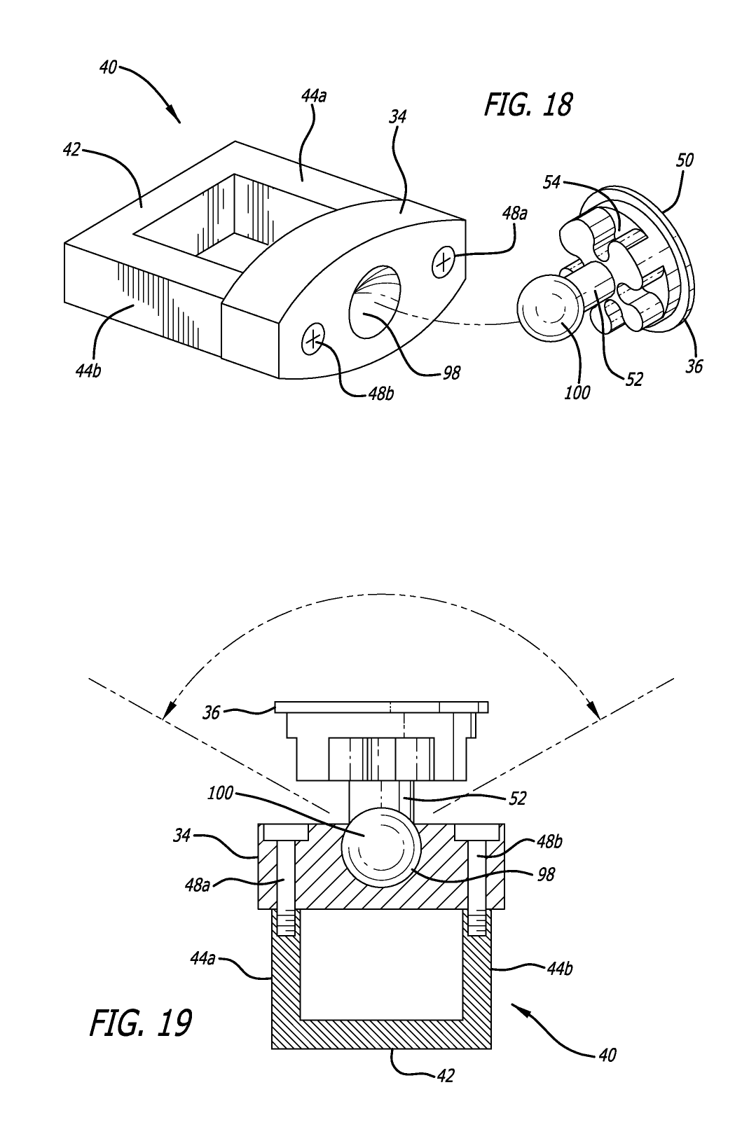

FIGS. 16-19 broadly depict another embodiment, of the flange assembly 32 in accordance with the invention, ideally suited for use with an object, such as a walker W having and angled post portions 98a and 98b. As broadly embodied, e.g., in FIGS. 17-19, first flange portion 34 of this embodiment has a recess defining a socket 98 defined therein. A distal end of shaft 52 of second flange portion 36 includes a generally spherical ball 100, configured to fit into the socket 98, to define a ball and socket configuration, enabling second flange portion 36 to pivot in a wide range of angles with respect to the post portion 98b and the first flange portion 84

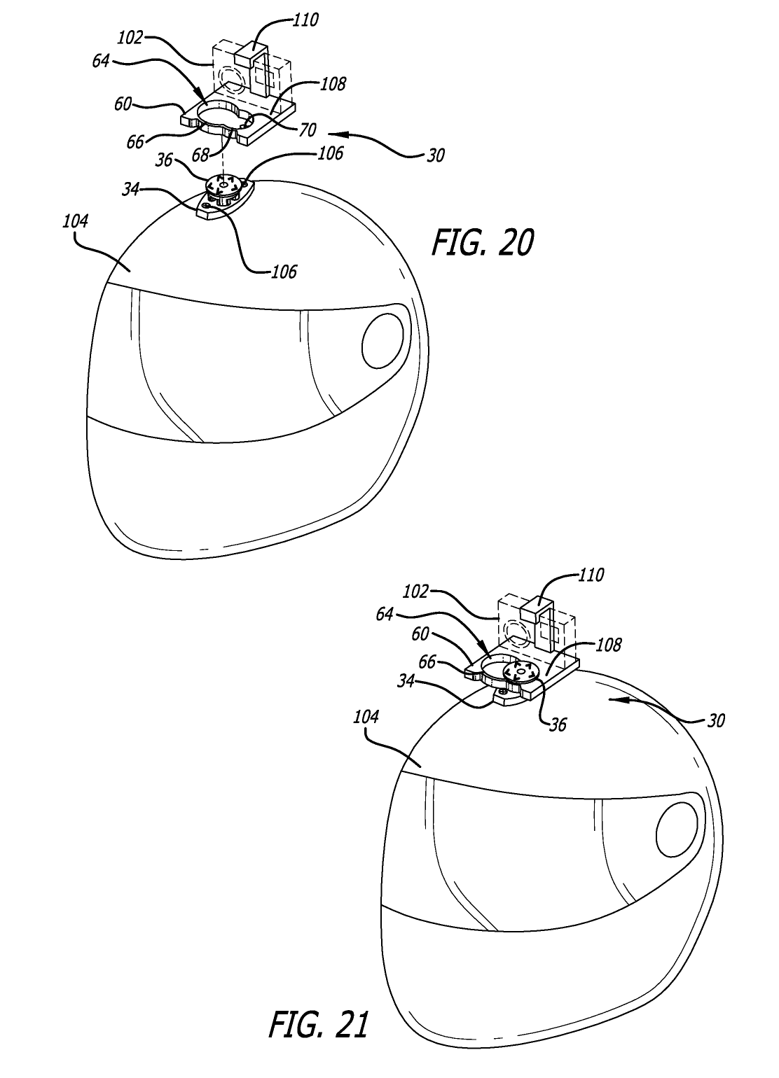

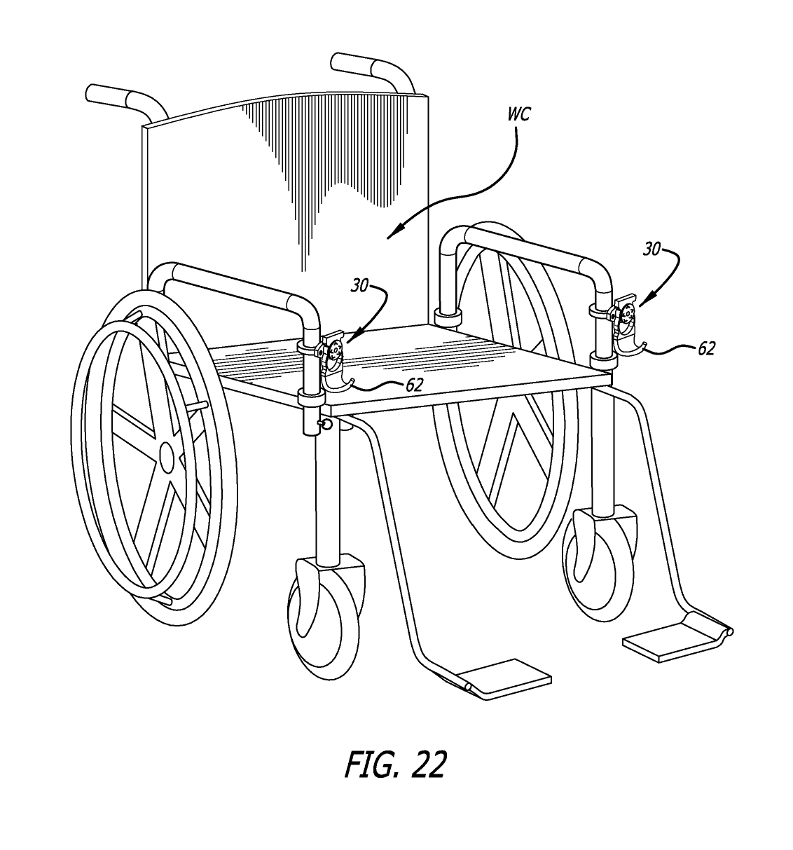

FIGS. 20-21 depict another embodiment of the present invention, particularly useful for mounting an object such as, e.g. a camera 102 to a sports helmet 104, e.g., a diving helmet or a skiing helmet. As broadly embodied in FIGS. 20 and 21, the first flange portion 34 attaches directly to the helmet 104, e.g., with fasteners such as cross-head screws 106. Key-hole plate 60 in this embodiment includes a base 108, wherein the figure 8-opening 64 is defined, and a generally L-shaped spring-loaded portion 110 projecting generally transversely from the base 108. The camera 102 is temporarily held in place between the generally L-shaped portion 110 and the base by the spring force in the generally L-shaped portion 110.

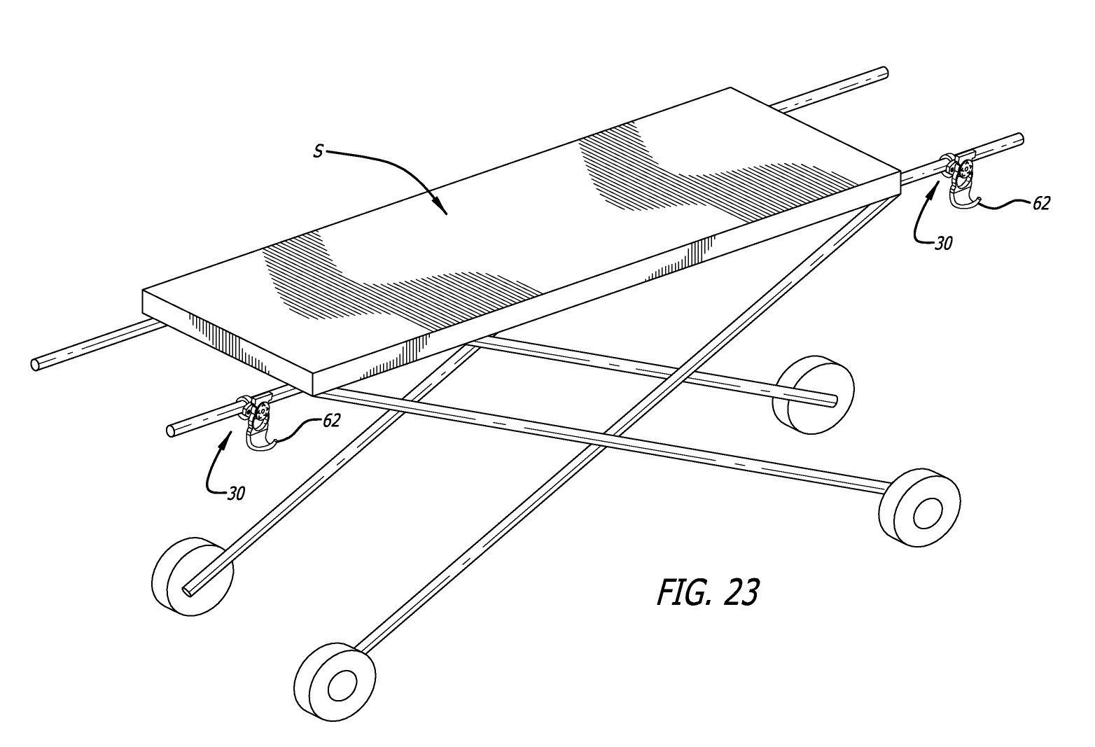

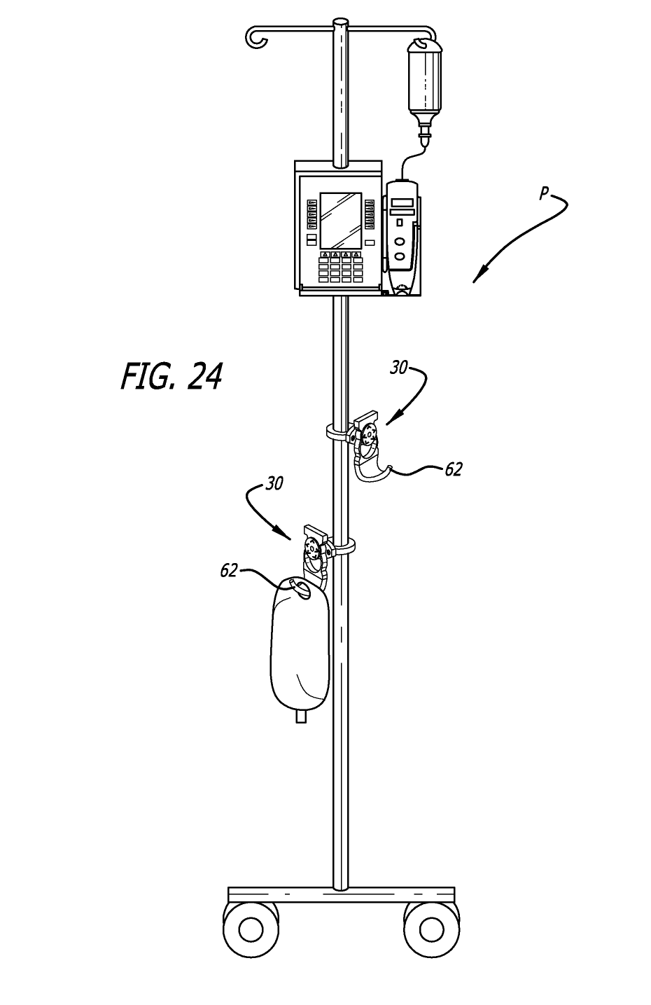

FIGS. 22-24 depict use of the present invention with objects often used by hospital and emergency responder personnel, whom regularly lack free hands to hold on to accessories, e.g., medical accessories such as I.V. bags, blood bags, catheter bags, cardio-respiratory equipment, medical charts, and patient personal items, for use on medical objects, such as, e.g., a wheelchair WC, a stretcher S, and a rolling medical bag hanger post P.

As depicted, e.g., in FIGS. 1-3, a walker W may include a vertical post 49a, a horizontal post 49b, and an angled support post 49c. The removable accessory clip system 30 and flange 32 for a removable accessory clip system can be attached to the angled post 49c, for example a 45 degree post. In this embodiment, the second flange portion 36 can be configured to rotate with respect to the first flange portion 34, for example by loosening the attachment fastener 36. In this manner, despite a 45 degree orientation of first flange portion 34, second flange portion 36, and key-hole plate 60 can be rotated back to a vertical orientation, thereby retaining accessory holding structure 62 in a desired vertical orientation.

Persons of ordinary skill will understand that the present invention can be modified to be used with objects having different shapes. For example. FIG. 6 depicts a tubular pipe portion 112. In order to attach the accessory clip 30 of the invention to tubular pipe portion 112, an inner face 114 of third flange base portion 42 is generally concave. In contrast, referring to FIGS. 7-8, which depict a generally rectangular pipe portion 116, the inner face 114 of third flange base portion 42 is generally planar. In FIGS. 20-21, wherein the surface of helmet 104 has a generally convex outer surface configuration, the third flange portion 40 is not used, and an inner face (not shown) of the first flange portion 34 is generally concave to a degree complimentary to the arc of the generally convex surface of the helmet 104, in order to achieve a good fit.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A removable accessory clip system for temporarily holding at least one of a plurality of accessories to an object, comprising:
a flange assembly removably attachable to the object, the flange assembly including at least a first flange portion, and at least a second flange portion attachable to the first portion;
a key-hole plate removably attachable to the second flange portion via a snap-fit; and
an accessory-holding structure attached to the key-hole plate configured to temporarily hold the at least one of the plurality of accessories.

2. The accessory clip system of claim 1, wherein the flange assembly further comprises a third flange portion, the third flange portion having a base portion, and first and second legs ending in respective first and second distal ends, the base portion and first and second legs defining a generally C-shaped portion, the base portion configured to fit against a portion of a pipe, the first flange portion being removably attachable to at least one of the first and second distal ends to substantially enclose the portion of the pipe.

3. The accessory clip system of claim 1, wherein the first flange portion defines a generally oval shape.

4. The accessory clip system of claim 1, wherein the second flange portion includes a face portion attached to a shaft portion, the shaft portion projecting substantially normal with respect to a plane defined by the first flange portion, the shaft portion including a selected number of slots defined in a surface thereof.

5. The accessory clip system of claim 4, wherein the face portion comprises at least one arrow defined thereon positioned to point to the at least one of the slots.

6. The accessory clip system of claim 4, wherein the face portion has a generally circular configuration.

7. The accessory clip system of claim 1, wherein the key-hole plate further comprises a tooth portion, configured to project into at least one of the slots.

8. The accessory clip system of claim 1, wherein the key-hole plate has an opening defined therein, the opening having a substantial figure-8 shape, including a first opening portion having a first diameter, and a second opening portion having a second diameter smaller than the first diameter.

9. The accessory clip system of claim 8, wherein the second flange portion is configured to be inserted through the first opening portion of the substantial figure 8-shape, and to be removably held in place in the second opening via the snap-fit.

10. The accessory clip system of claim 1, wherein the accessory-holding structure is removable from the key-hole plate.

11. The accessory dip system of claim 1, wherein the key-hole plate comprises a generally rectangular base plate with a generally C-shaped opening defined in one edge thereof, the generally C-shaped opening being attachable to the second flange portion to be rotatable with respect to the flange assembly.

12. The accessory clip system of claim 11, wherein the key-hole plate further comprises at least one projecting portion engageable with the second flange portion.

13. The accessory clip system of claim 1, wherein the first flange portion comprises an opening defining a socket, and the second flange portion comprises a sphere, insertable into the socket to define a rotatable ball and socket flange assembly.

14. The accessory clip system of claim 13, wherein the bail and socket flange assembly is attachable to a portion of one of two posts which meet to define an angle.

15. The accessory clip system of claim 1, wherein the second flange portion is rotatable with respect to the first flange portion.

16. The accessory clip system of claim 1, wherein the accessory-holding structure comprises at least one selected from the group consisting of a cup holder, an I.V. bag hanger, a blood bag hanger, a catheter bag hanger, a personal items bag hook, a briefcase holder, a flashlight clamp, and a camera clamp.

17. The accessory clip system of claim 1, wherein the object comprises at least one of the group consisting of a generally tubular pipe, a generally rectangular pipe, a substantially vertical pipe portion of a walker, a substantially horizontal pipe portion of a walker, an angled pipe portion of a walker, a pipe portion of a stretcher, a pipe portion of a wheelchair, a cane, a portion of an I.V. bag hanging post, a pipe portion of a hospital bed, and a surface of a helmet.

18. The accessory clip system of claim 17, wherein the key-hole plate of the clip removably attachable to the cane is configured to removably hold a flashlight rotatably with respect to an axis defined by a vertical portion of the cane.

19. The accessory clip system of claim 17, wherein the key-hole plate of the clip removably attachable to the helmet is configured to removably hold a camera.

20. A flange assembly configured for removable attachment to an accessory clip system for temporarily holding at least one of a plurality of accessories on an object, the flange assembly comprising;
at least a first flange portion removably attachable to the object; and
at least a second flange portion attachable to the first portion;
wherein the second flange portion includes a face portion, and a shaft portion, the shaft portion projecting substantially normal with respect to a plane defined by the first flange portion, the shaft portion including a selected number of slots defined therein.

21. The flange assembly of claim 20, further comprising a third flange portion, the third flange portion having a base portion, and first and second legs ending in respective first and second distal ends, the base portion and first and second legs defining a generally C-shaped portion, the base portion configured to fit against a portion of a pipe, and the first, flange portion being removably attachable to at least one of the first and second distal ends to substantially enclose the portion of the pipe.

22. The flange assembly of claim 20, wherein the second flange portion is configured to have a key-hole plate portion of the accessory clip system removably attached thereto with a snap-fit, the key-hole plate comprising accessory-holding structure.
